(19) United States
(12) Patent Application Publication
(10) Pub. No.: US 2008/0051049 A1
(43) Pub. Date: Feb. 28, 2008

(54) Reception circuit and receiver

(75) Inventors: Nobuhiro Katoh, Soraku-gun (JP); Yasuhiro Wada, Osaka (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/889,311

(22) Filed: Aug. 10, 2007

(30) Foreign Application Priority Data
Aug. 22, 2006 (JP) 2006-225672

(51) Int. Cl. H04B 1/16

(52) U.S. Cl. 455/205

(57) ABSTRACT

A reception circuit receives a digital modulated high frequency signal and is equipped with a plurality of reception systems for receiving the same reception frequency. At least two reception systems share a voltage controlled oscillator of a frequency converting portion that performs frequency conversion of a signal based on the digital modulated high frequency signal, a reference signal oscillator, and a PLL circuit that generates a control voltage based on an output signal of the voltage controlled oscillator and a reference signal delivered from the reference signal oscillator and controls the voltage controlled oscillator based on the control voltage. The frequency converting portion delivers an intermediate frequency signal. The reception circuit includes an intermediate frequency variable gain amplifier that receives a signal based on the intermediate frequency signal. The frequency converting portion and the intermediate frequency variable gain amplifier are integrated into a single IC package, so that cost reduction and space saving can be achieved.

This nonprovisional application claims priority under 35 U.S.C. §119(a) on Patent Application No. 2006-225672 filed in Japan on Aug. 22, 2006, the entire contents of which are hereby incorporated by reference.

### BACKGROUND OF THE INVENTION

1. Field of the Invention

The present invention relates to a reception circuit and a receiver for receiving a digital modulated high frequency signal.

2. Description of Related Art

A conventional receiver will be described with reference to an example of a receiver that receives ground wave digital broadcasting for a mobile unit. Reception by a mobile unit has a disadvantage compared with reception by a fixed unit, because the former causes a variation of a reception level or fading of an antenna. Therefore, a diversity method is usually used in a receiver that receives ground wave digital broadcasting for a mobile unit, so that reception performance (quality) can be improved.

A conventional example of a general structure of the receiver that receives ground wave digital broadcasting for a mobile unit is shown in FIG. 3. The conventional receiver shown in FIG. 3 adopts the diversity method and a single conversion method (see the structure shown in FIG. 4 that will be described later) and includes antennas 1 and 2, tuners 3 and 4, demodulation circuits 5 and 6, a reference signal oscillator 7 and an MPEG (Moving Picture Experts Group) decoder 8. The antennas 1 and 2 are connected to the input terminals of the tuners 3 and 4, respectively, and the demodulation circuits 5 and 6 are disposed after the tuners 3 and 4, respectively. The MPEG decoder 8 is disposed after the demodulation circuits 5 and 6.

The tuners 3 and 4 perform a tuning operation using a reference signal that is supplied from the reference signal oscillator 7. For example, in order to receive a broadcasting signal of a certain frequency (channel), the two tuners 3 and 4 should receive the broadcasting signal of the same frequency, so the single reference signal oscillator is sufficient. Then, the MPEG decoder 8 compares a demodulated signal from the demodulation circuit 5 with a demodulated signal from the demodulation circuit 6, and it selects one of the demodulated signals that has better quality (i.e., the demodulated signal that has lower bit error rate) so as to perform an expansion process on it. Thus, reception performance (quality) can be improved.

Next, a tuner circuit portion including the tuners 3 and 4 and the reference signal oscillator 7, which is a part of the conventional reception apparatus shown in FIG. 3, is shown in FIG. 4. Note that the same part as in FIG. 3 is denoted by the same numeral in FIG. 4.

As to the tuner 3, a digital modulated high frequency signal is supplied from the antenna 1 (not shown in FIG. 4) to a tuner input terminal 11, and first a band pass filter 12 selects only a reception band (an entire reception broadcasting frequency band) while other frequency components are eliminated. Then, a signal of the reception band selected by the band pass filter 12 is amplified by a broadband amplifier 13.

An output signal of the broadband amplifier 13 is tuned by an input circuit 14, and its gain is adjusted by an RFAGC (Radio Frequency Auto Gain Control) amplifier 15. Further, a band of the signal is restricted by an interstage circuit 16, so that unnecessary frequency components are eliminated.

An MOPLL (Mixer Oscillator Phase Locked Loop), which is made up of a PLL circuit 17, a voltage controlled oscillator 18, a mixer 19 and an amplifier 20, downconverts an output signal of the interstage circuit 16 into an intermediate frequency signal. The PLL circuit 17 generates a control voltage corresponding to a received channel based on the reference signal delivered from the reference signal oscillator 7 and a local oscillation signal delivered from the voltage controlled oscillator 18. The voltage controlled oscillator 18 generates the local oscillation signal of the local oscillation frequency (that is a sum of the reception frequency and a frequency of the intermediate frequency signal) in accordance with the control voltage from the PLL circuit 17. The mixer 19 mixes the output signal of the interstage circuit 16 and the local oscillation signal from the voltage controlled oscillator 18 so as to generate the intermediate frequency signal. The intermediate frequency signal delivered from the mixer 19 is amplified by the amplifier 20 and then is supplied to a SAW (Surface Acoustic Wave) filter 21 disposed after the MOPLL.

A band of the intermediate frequency signal delivered from the MOPLL is restricted by the SAW filter 21 so that unnecessary frequency components such as a neighboring channel component and the like are eliminated. Then, a gain of the signal is adjusted by an IFAGC (Intermediate Frequency Auto Gain Control) amplifier 22, and the signal is delivered from output terminals 23 and 24 of the tuner to the successive demodulation circuit (not shown in FIG. 4).

Similarly concerning the tuner 4, a digital modulated high frequency signal is supplied from the antenna 2 (not shown in FIG. 4) to a tuner input terminal 31, and first a band pass filter 32 selects only a reception band (an entire reception broadcasting frequency band) while other frequency components are eliminated. Then, a signal of the reception band selected by the band pass filter 32 is amplified by a broadband amplifier 33.

An output signal of the broadband amplifier 33 is tuned by an input circuit 34, and its gain is adjusted by an RFAGC (Radio Frequency Auto Gain Control) amplifier 35. Further, a band of the signal is restricted by an interstage circuit 16, so that unnecessary frequency components are eliminated.

An MOPLL (Mixer Oscillator Phase Locked Loop), which is made up of a PLL circuit 37, a voltage controlled oscillator 38, a mixer 39 and an amplifier 40, downconverts an output signal of an interstage circuit 36 into an intermediate frequency signal. The PLL circuit 37 generates a control voltage corresponding to a received channel based on the reference signal delivered from the reference signal oscillator 7 and a local oscillation signal delivered from the voltage controlled oscillator 38. The voltage controlled oscillator 38 generates the local oscillation signal of the local oscillation frequency (that is a sum of the reception frequency and a frequency of the intermediate frequency signal) in accordance with the control voltage from the PLL circuit 37. The mixer 39 mixes the output signal of the interstage circuit 36 and the local oscillation signal from the voltage controlled oscillator 38 so as to generate the intermediate frequency signal. The intermediate frequency signal delivered from the mixer 39 is amplified by the amplifier 40 and then is supplied to a SAW (Surface Acoustic Wave) filter 41 disposed after the MOPLL.

A band of the intermediate frequency signal delivered from the MOPLL is restricted by the SAW filter 41 so that unnecessary frequency components such as a neighboring channel component and the like are eliminated. Then, a gain of the signal is adjusted by an IFAGC (Intermediate Frequency Auto Gain Control) amplifier 42, and the signal is delivered from output terminals 43 and 44 of the tuner to the successive demodulation circuit (not shown in FIG. 4).

However, the conventional receiver shown in FIG. 3, which includes the tuner circuit portion having the structure shown in FIG. 4, is equipped with two tuners 3 and 4 having individual MOPLLs for receiving the same reception frequency (see FIG. 4), so this structure needs high cost.

Furthermore, the receiver disclosed in FIG. 2 of Japanese registered utility model No. 3004362 has two reception systems that receive signals of different frequency bands, so it is not the structure in which a plurality of reception systems receive the same reception frequency.

### SUMMARY OF THE INVENTION

An object of the present invention is to provide a reception circuit and a receiver of an inexpensive structure in which a plurality of reception systems receive the same reception frequency.

A reception circuit of the present invention receives a digital modulated high frequency signal and is equipped with a plurality of reception systems for receiving the same reception frequency. At least two reception systems share a voltage controlled oscillator of a frequency converting portion that performs frequency conversion of a signal based on the digital modulated high frequency signal, a reference signal oscillator, and a PLL circuit that generates a control voltage based on an output signal of the voltage controlled oscillator and a reference signal delivered from the reference signal oscillator and controls the voltage controlled oscillator based on the control voltage. The frequency converting portion delivers an intermediate frequency signal. The reception circuit includes an intermediate frequency variable gain amplifier that receives a signal based on the intermediate frequency signal. The frequency converting portion and the intermediate frequency variable gain amplifier are integrated into a single IC package.

According to this structure, since the voltage controlled oscillator of the frequency converting portion, the reference signal oscillator and the PLL circuit are shared by at least two reception systems, cost reduction and space saving can be achieved.

In addition, according to this structure, since the frequency converting portion and the intermediate frequency variable gain amplifier are integrated into a single IC package, further cost reduction and space saving can be achieved.

In addition, as to the reception circuit having the structure described above, the reception circuit may be a reception circuit for diversity reception.

In addition, as to the reception circuit having the structures described above, the reception circuit may be housed in a single case.

In addition, as to the reception circuit having the structures described above, the reception circuit may be a circuit that delivers an intermediate frequency.

In addition, a receiver of the present invention includes the reception circuit having any one of the structures described above and a plurality of demodulation circuits that are connected to output terminals of the reception circuit.

In addition, as to the receiver having the structure described above, a signal based on a reference signal delivered from a reference signal oscillator of the frequency converting portion of the reception circuit may be used as a clock signal of the plurality of demodulation circuits.

In addition, as to the receiver having the structure described above, the reception circuit and the plurality of demodulation circuits may be integrated into a single IC package.

In addition, the receiver having the structure described above may include a substrate, and the reception circuit and the plurality of demodulation circuits may be mounted on a single side or both sides of the substrate.

In addition, the receiver having the structure described above may include a demodulated signal processing circuit that processes at least one of output signals of the plurality of demodulation circuits, and the reception circuit, the plurality of demodulation circuits and the demodulated signal processing circuit may have a module structure.

### BRIEF DESCRIPTION OF THE DRAWINGS

FIG. 1 is a diagram showing an example of a structure of a receiver according to the present invention.

FIG. 2 is a diagram showing another example of a structure of the receiver according to the present invention.

FIG. 3 is a diagram showing an example of a general structure of a conventional receiver that receives ground wave digital broadcasting for a mobile unit.

FIG. 4 is a diagram showing an example of a structure of a tuner circuit portion that is provided to the reception apparatus shown in FIG. 3.

### DETAILED DESCRIPTION OF THE PREFERRED EMBODIMENTS

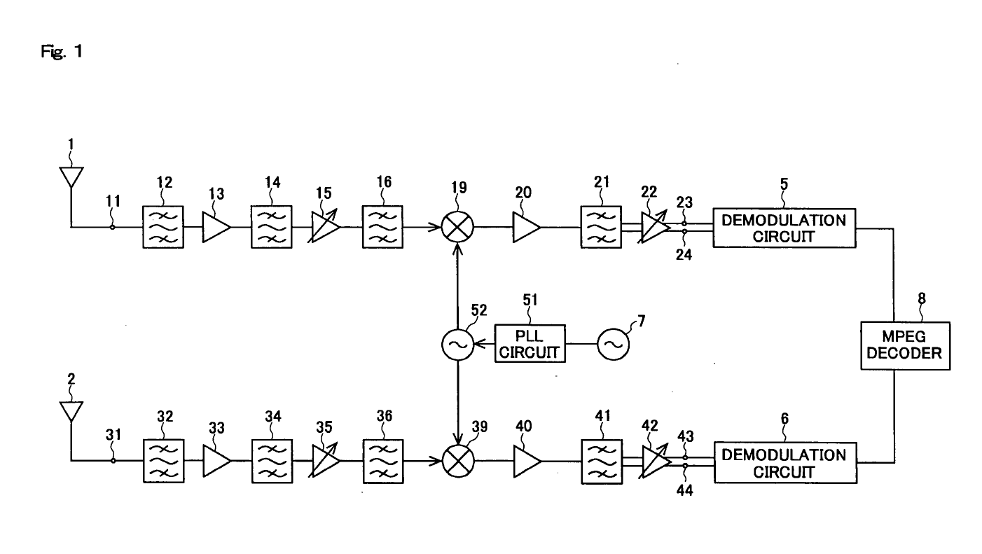

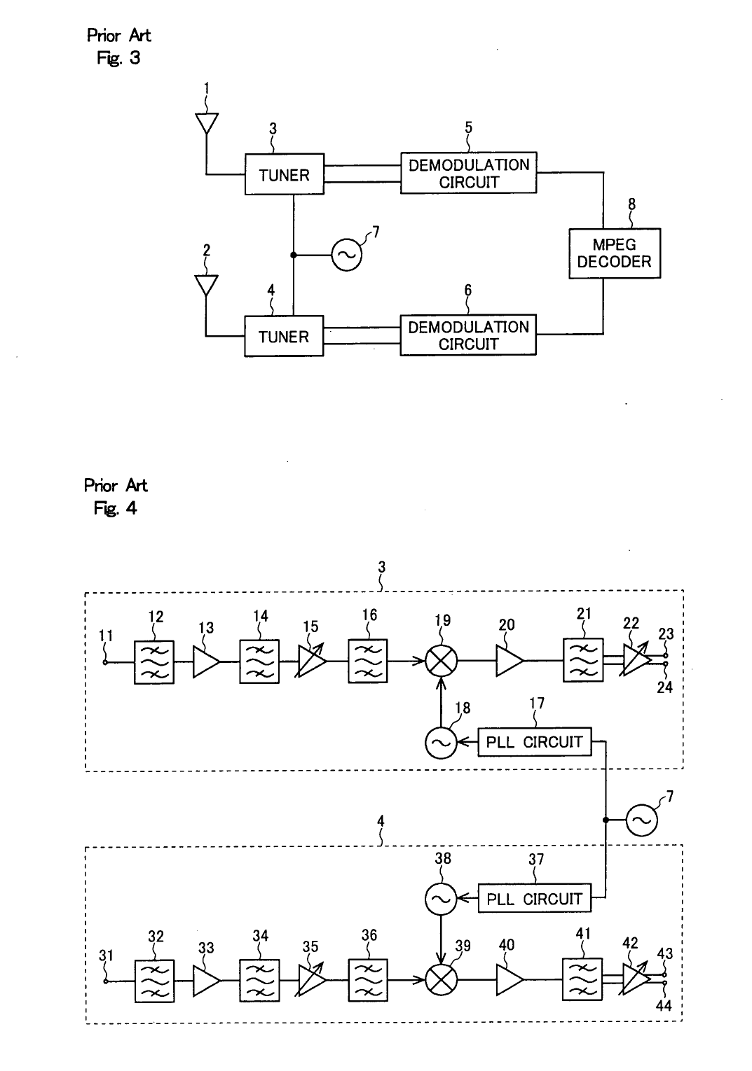

Hereinafter, an embodiment of the present invention will be described with reference to the attached drawings. A receiver that receives ground wave digital broadcasting for a mobile unit is exemplified as the receiver according to the present invention in the following description. An example of a structure of a receiver according to the present invention that receives ground wave digital broadcasting for a mobile unit is shown in FIG. 1. Note that the same part as that in FIGS. 3 and 4 is denoted by the same numeral in FIG. 1, so that detailed description thereof will be omitted.

The receiver shown in FIG. 1 according to the present invention adopts the diversity method and the single conversion method in the same manner as the conventional receiver shown in FIG. 3.

The receiver shown in FIG. 1 according to the present invention has a structure in which the PLL circuits 17 and 37 and the voltage controlled oscillators 18 and 38 are eliminated from the conventional receiver shown in FIG. 3 including the tuner circuit portion having the structure shown in FIG. 4, and a PLL circuit 51 and a voltage controlled oscillator 52 are added to the same, so that two reception systems share the PLL circuit 51 and the voltage controlled oscillator 52.

An operation of the receiver shown in FIG. 1 according to the present invention having the structure described above will be described only about differences with the conventional receiver shown in FIG. 3 that includes the tuner circuit portion having the structure shown in FIG. 4.

The PLL circuit 51 generates a control voltage corresponding to a received channel based on the reference signal delivered from the reference signal oscillator 7 and a local oscillation signal delivered from the voltage controlled oscillator 52. The voltage controlled oscillator 52 generates the local oscillation signal of a local oscillation frequency (that is a sum of the reception frequency and a frequency of the intermediate frequency signal) based on the control voltage from the PLL circuit 51, and the generated local oscillation signal is supplied to the mixers 19 and 39.

The mixer 19 mixes the output signal of the interstage circuit 16 and the local oscillation signal from the voltage controlled oscillator 52 so as to generate the intermediate frequency signal. The intermediate frequency signal delivered from the mixer 19 is amplified by the amplifier 20 and then is supplied to a SAW (Surface Acoustic Wave) filter 21 disposed after. In addition, the mixer 39 mixes the output signal of the interstage circuit 36 and the local oscillation signal from the voltage controlled oscillator 52 to as to generate the intermediate frequency signal. The intermediate frequency signal delivered from the mixer 39 is amplified by the amplifier 40 and is supplied to a subsequent SAW (Surface Acoustic Wave) filter 41.

Since the receiver shown in FIG. 1 according to the present invention has a structure in which the PLL circuit 51 and the voltage controlled oscillator 52 are shared by two reception systems, one PLL circuit and one voltage controlled oscillator can be eliminated from the conventional receiver shown in FIG. 3 including the tuner circuit portion having the structure shown in FIG. 4. Therefore, cost reduction and space saving can be achieved.

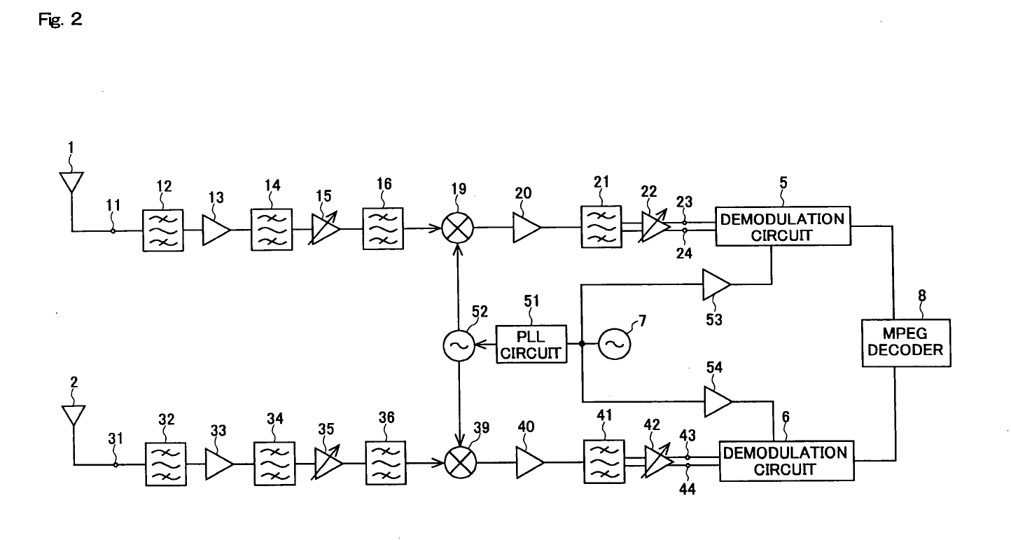

Next, another example of a structure of a receiver according to the present invention that receives ground wave digital broadcasting for a mobile unit is shown in FIG. 2. Note that the same part as that in FIG. 1 is denoted by the same numeral in FIG. 2, so that detailed description thereof will be omitted.

The receiver shown in FIG. 2 according to the present invention distributes the reference signal delivered from the reference signal oscillator 7 into three. One of them is supplied to the PLL circuit 51, another is supplied to the demodulation circuit 5 after its signal level is secured by an amplifier 53, and the other is supplied to the demodulation circuit 6 after its signal level is secured by an amplifier 54. If a frequency of the reference signal delivered from the reference signal oscillator 7 does not match the clock frequency necessary for the demodulation circuits 5 and 6, a multiplier or a divider should be disposed before or after each of the amplifiers 53 and 54 so that a clock signal of a clock frequency necessary for the demodulation circuits 5 and 6 can be obtained.

The receiver shown in FIG. 2 according to the present invention does not need a special clock signal source for generating a clock signal to be the reference signal of the demodulation circuit. On the contrary, the receiver shown in FIG. 1 according to the present invention or the conventional receiver shown in FIG. 3 including the tuner circuit portion having the structure shown in FIG. 4 is provided with a special clock signal source for generating a clock signal to be the reference signal of the demodulation circuit thought it is not shown in the drawings. Therefore, the receiver shown in FIG. 2 according to the present invention can achieve further cost reduction and space saving compared with the receiver shown in FIG. 1 according to the present invention.

In addition, in order to achieve further cost reduction and space saving in the receiver shown in FIG. 1 or 2 according to the present invention, the mixers 19 and 39, the amplifiers 20 and 40, the PLL circuit 51, the voltage controlled oscillator 52, and the IFAGC amplifiers 22 and 42 are integrated into a single IC package.

As to the receiver shown in FIG. 1 or 2 according to the present invention, the reception circuit is made up of the tuner input terminals 11 and 31, the band pass filters 12 and 32, the broadband amplifiers 13 and 33, the input circuits 14 and 34, the RFAGC amplifiers 15 and 35, the interstage circuits 16 and 36, the mixers 19 and 39, the reference signal oscillator 7, the PLL circuit 51, the voltage controlled oscillator 52, the amplifiers 20 and 40, the SAW filters 21 and 41, the IFAGC amplifiers 22 and 42, the tuner output terminals 23, 24, 43 and 44.

The receiver shown in FIG. 1 or 2 according to the present invention has the structure in which the PLL circuit 51 and the voltage controlled oscillator 52 are shared by two reception systems, so it is easy to house the two reception systems in a single case. Therefore, it is preferable to house the reception circuit in a single case.

In addition, since the reception circuit described above is a circuit that delivers the intermediate frequency, a user who handles the reception circuit as a component can freely select the demodulation circuits 5 and 6 that are disposed after the reception circuit.

In addition, from a viewpoint of cost reduction and space saving, it is possible to integrate the reception circuit and the demodulation circuits 5 and 6 into a single IC package. In this case, it is preferable to mount the reception circuit and the demodulation circuits 5 and 6 on individual chips that constitute an IC package of MCP (Multi Chip Package), so that it is relatively easy to select the demodulation circuits 5 and 6 that are disposed after the reception circuit.

In addition, it is preferable to mount the reception circuit and the demodulation circuits 5 and 6 on both sides or on a single side of a mother board of a final product (the receiver).

In addition, as to the receiver shown in FIG. 1 or 2 according to the present invention, it is preferable that the reception circuit, the demodulation circuit 5 and the MPEG decoder 8 have a module structure. Thus, it becomes easier to manage total cost of the reception circuit, the demodulation circuit 5 and the MPEG decoder 8. In addition, the module structure enables generalization so that cost reduction can be achieved, and it becomes easier for designers of set manufacturers or TV manufacturers to use.

Note that although the receiver that utilizes the single conversion method is exemplified in the embodiment described above, it is clear that the present invention can also be applied to a receiver that uses a double conversion method or a receiver that uses a direct conversion method.

What is claimed is:

1. A reception circuit that receives a digital modulated high frequency signal and is equipped with a plurality of reception systems for receiving the same reception frequency, wherein
at least two reception systems share a voltage controlled oscillator of a frequency converting portion that performs frequency conversion of a signal based on the digital modulated high frequency signal, a reference signal oscillator, and a PLL circuit that generates a control voltage based on an output signal of the voltage controlled oscillator and a reference signal delivered from the reference signal oscillator and controls the voltage controlled oscillator based on the control voltage,
the frequency converting portion delivers an intermediate frequency signal,
the reception circuit includes an intermediate frequency variable gain amplifier that receives a signal based on the intermediate frequency signal, and
the frequency converting portion and the intermediate frequency variable gain amplifier are integrated into a single IC package.

2. The reception circuit according to claim 1, wherein the reception circuit is a reception circuit for diversity reception.

3. The reception circuit according to claim 1, wherein the reception circuit is housed in a single case.

4. The reception circuit according to claim 1, wherein the reception circuit is a circuit that delivers an intermediate frequency.

5. A receiver comprising:
a reception circuit; and
a plurality of demodulation circuits that are connected to output terminals of the reception circuit, wherein
the reception circuit receives a digital modulated high frequency signal and is equipped with a plurality of reception systems for receiving the same reception frequency,
at least two reception systems of the reception circuit share a voltage controlled oscillator of a frequency converting portion that performs frequency conversion of a signal based on the digital modulated high frequency signal, a reference signal oscillator, and a PLL circuit that generates a control voltage based on an output signal of the voltage controlled oscillator and a reference signal delivered from the reference signal oscillator and controls the voltage controlled oscillator based on the control voltage,
the frequency converting portion delivers an intermediate frequency signal,
the reception circuit includes an intermediate frequency variable gain amplifier that receives a signal based on the intermediate frequency signal, and
the frequency converting portion and the intermediate frequency variable gain amplifier are integrated into a single IC package.

6. The receiver according to claim 5, wherein the reception circuit is a reception circuit for diversity reception.

7. The receiver according to claim 5, wherein the reception circuit is housed in a single case.

8. The receiver according to claim 5, wherein the reception circuit is a circuit that delivers an intermediate frequency.

9. The receiver according to claim 5, wherein a signal based on a reference signal delivered from a reference signal oscillator of the frequency converting portion of the reception circuit is used as a clock signal of the plurality of demodulation circuits.

10. The receiver according to claim 5, wherein the reception circuit and the plurality of demodulation circuits are integrated into a single IC package.

11. The receiver according to claim 5, wherein the receiver includes a substrate, and the reception circuit and the plurality of demodulation circuits are mounted on a single side or both sides of the substrate.

12. The receiver according to claim 5, wherein the receiver includes a demodulated signal processing circuit that processes at least one of output signals of the plurality of demodulation circuits, and the reception circuit, the plurality of demodulation circuits and the demodulated signal processing circuit have a module structure.
